(19) United States
(12) Patent Application Publication
(10) Pub. No.: US 2017/0012913 A1
(43) Pub. Date: Jan. 12, 2017

(54) Social media system and method based on category classification of message and combination of category affinity and personal affinity of users

(71) Applicant: Suman Lohani, Surrey (CA)

(72) Inventor: Suman Lohani, Surrey (CA)

(73) Assignee: Suman Lohani, Kenmore, WA (US)

(21) Appl. No.: 14/795,842

(22) Filed: Jul. 9, 2015

(51) Int. Cl. H04L 12/58; H04L 29/08

(52) U.S. Cl. CPC H04L 51/16; H04L 67/306; H04L 51/10; H04L 67/22

(57) ABSTRACT

A social media system and method is described for providing post feed to user interface wherein users have greater capability of managing the feeds from user interface provided on their device. Connection strength to users is set both manually by the user as well as automatically by an interest algorithm. Similarly connection strength to subject categories of interest is set both manually by the user as well as automatically by an interest algorithm.

The mentioned social media system and method also processes and provides ways of determining related Topics and group them under predefined or user defined specified categories. To further enhance user experience, the system presents separate feeds on segmented sections of the interface.

### BACKGROUND

The term web 2.0 was coined in 1999 to represent dynamic websites. Social websites are a progression of the evolution of the web 2.0.

People have been searching online for contacts, life partners, friendships and more shortly after the first messages began being passed to each other. Simple criteria based websites like matches.com, lotsoffish.com have been created some as subscription based service.

There has been a saying since time immemorial that “Birds of a feather flock together”. The present invention gives power to the users who can decide what type of content they want to view and what clique they create to share their life stories.

### DETAILED DESCRIPTION

The present disclosure generally relates to data processing techniques. More specifically the present disclosure relates to methods and systems for enhancing the user experience of viewing, creating, categorizing and sharing posts which may be known as journal entries, diary and records. In combination with this, the system and method in present disclosure provides a platform where users can find like minded people with whom they'd like to start closer communications and exchange of ideas. Categories from the category database may be added to the user profiles based on their interest mined from user interactions with the system.

Existing social media systems provide user with a like button or an upvote and downvote button. However this does not encompass all user sentiments such as express appreciation to poster for sharing the post with the first user or as case may be to like the content of the posting. In the system described affinity expression is differentiated into personal affinity and category affinity. In this way of differentiation a first user can view list of liked posts due to category or post content as well as be presented with cases when the second user appreciated sharing of the post regardless of the content.

### BRIEF DESCRIPTION OF THE DRAWINGS

The drawing figures depict one or more implementations in accord with the present concepts, by way of example only, not by way of limitations.

FIG. 1 illustrates an exemplary architecture that is consistent with the principles of the present invention;

FIG. 2 illustrates a schematic diagram of feed transmission;

FIG. 3 illustrates an exemplary architecture that is consistent with the principles of the present invention;

FIG. 4 illustrates a schematic diagram for Affinity Algorithm

FIG. 5 is a flow diagram of an exemplary process for flow of posts to users

FIG. 6 illustrates a webpage implementing an exemplary interface displaying the user walls view;

FIG. 7 illustrates a view of categories and subcategories displayed on an exemplary interface for managing categories and subcategories

FIG. 8 is a flow diagram of an exemplary process for adding categories and subcategories to user profile

FIG. 9 is a flow diagram of an exemplary process for presenting the content of a post in a user device

FIG. 10 is a flow diagram of an exemplary process for login into the system and signup

FIG. 11 is a flow diagram of an exemplary process for personal affinity algorithm;

FIG. 12 is a flow diagram of an exemplary process for adding new category or subcategory;

FIG. 13 shows an exemplary graphical user interface for posting to the system;

FIG. 14 is a flow diagram of an exemplary process for post submission and transmission in the processor and feed generator of the system;

FIG. 15 is a flow diagram of an exemplary process for managing post's transmission;

FIG. 16 is a flow diagram of an exemplary process when a user likes a post;

FIG. 17 shows an exemplary graphical user interface for posting to friends with affinity index selected on a scale measuring system;

FIG. 18 shows an exemplary graphical user interface for managing personal affinity to contacts;

FIG. 19 shows an exemplary graphical user interface for posting to the system;

### DESCRIPTION OF THE DRAWINGS

This present system is a platform where people can create their life logs and share it. Then based on both their profile and the profile of viewing users the posts are shared. This encourages substantive contribution to expressed ideas on a variety of topics. This also allows deeper character buildup of participating contributors.

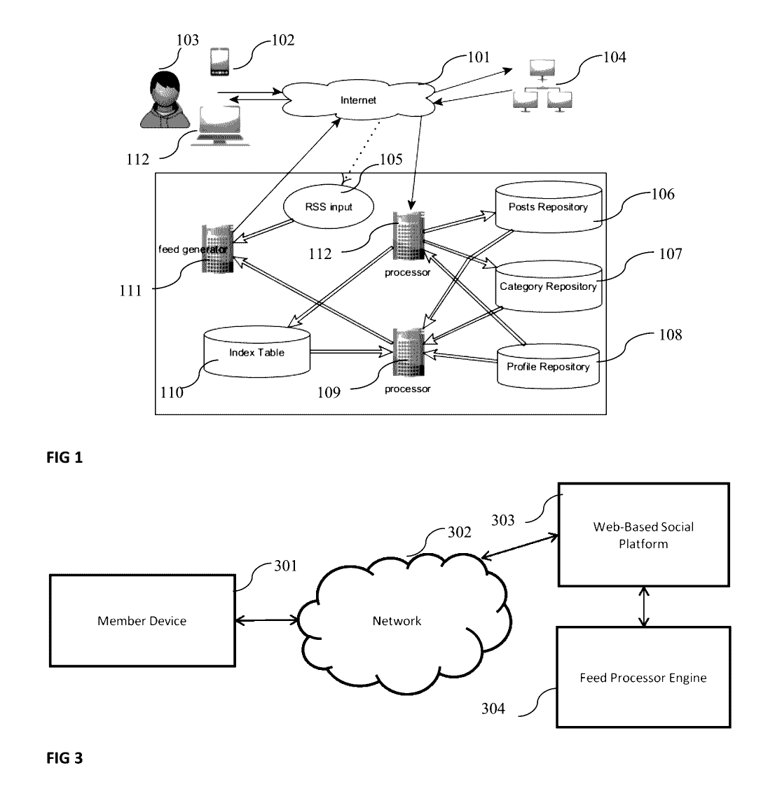

FIG. 1 illustrates an exemplary architecture that is consistent with the principles of the present invention. User input such as an exemplary Post from a user 103 goes to processor 112 which categorizes the post and adds post sub category tag. The processor 112 further stores data associated with a user 103 to profile repository 108 further indexing the contents of the repositories. The processor 109 retrieves the indexes from index table 110, retrieves feeds as per affinity algorithm of the system as defined and provides to feed generator which may further run affinity algorithm and defined filters on the posts and transmit the feed to user via the internet 101. Additionally the feed generator may get RSS input as per user preference and send it to the user assigned wall on the presentation system of the user using devices such as smart phone 102, computer 112 or any such communication devices. Feed generator provides feed to other network devices 104 via the internet 101.

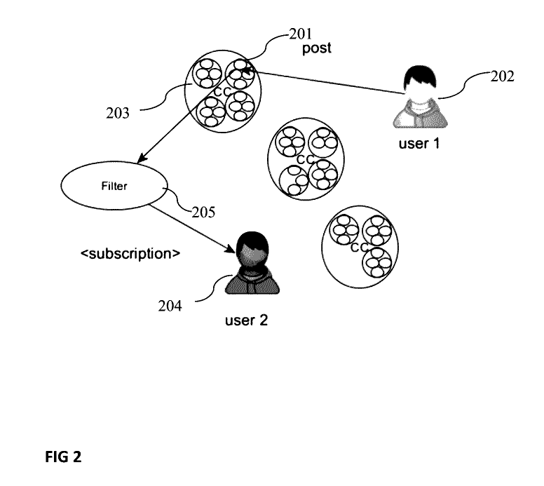

FIG. 2 illustrates a schematic diagram of an exemplary feed transmission processor in a social media environment. Post originator logs into the social media and creates post to a subcategory 201 belonging to category 203. Second User 204 who is subscribed to category 203 will receive the post if an optional additional filter 205 allows the post through.

As shown in FIG. 3 the member device 301 can be a wireless handless device communicating over a network 302 wirelessly. Web-Based Social Platform may be comprised of a number of different servers. In this exemplary architecture the feed processor engine generates list of posts to the user and submits it to a web application server on which the Web-Based Social platform 303 may be hosted.

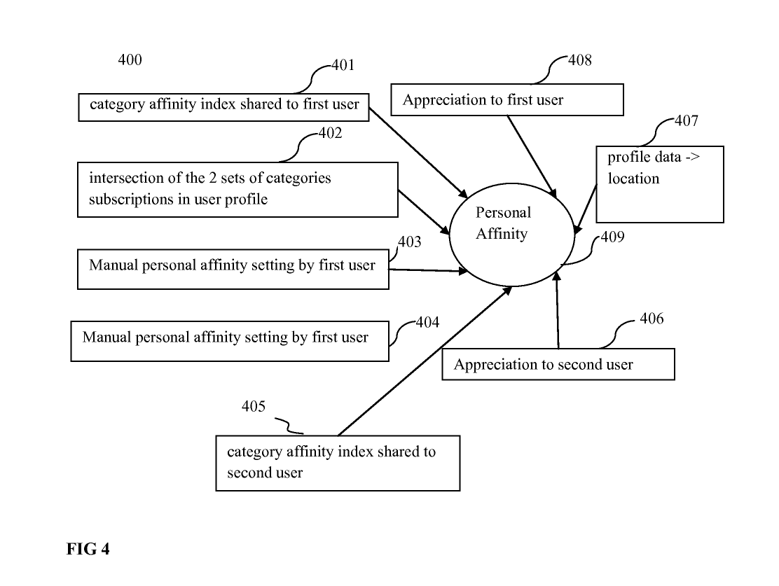

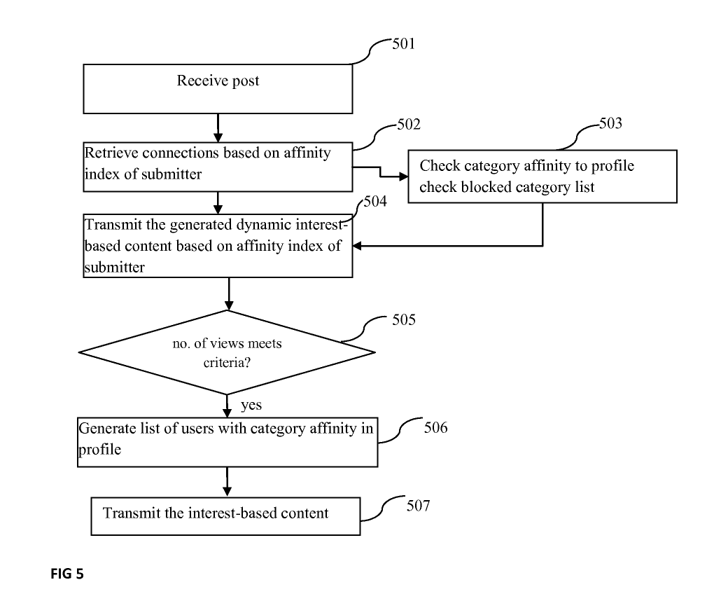

FIG. 4 illustrates a schematic diagram of an exemplary logic for Affinity algorithm 400 for contact suggestion that recommends the users to connect with individuals with whom they can further collaborate and share meaningful ideas. Affinity is measured by taking category classifications added to profile from first user 401 and corresponding data from second user 405 and personal affinity strength setting of first user 403 and corresponding data from second user 404. At block 407 profile data including common friends count, location data and manual affinity setting are inputs to the algorithm determining personal affinity. At block 406 and 408 the mutual appreciation is computed from data including personal appreciation count and set as input to the algorithm.

In the flowchart of FIG. 5 methodology for selectively displaying posts to users in a social network is disclosed. At Block 501, the method receives user submitted post containing assigned category. At block 502, It generates user lists from the process which retrieves the affinity index from user profile of submitting user. In block 503, the post is added to user feed after evaluating the category against blocked category list. In block 504, the post is added to feeds to connections based on affinity index of submitter. In block 505, the post has a number of user views which is evaluated against predefined criteria. In block 506, when the criterion is met then the post flows out to public users who are subscribed to the category. This allows that a post passes review from immediate friends who may have chance to further add categories to which the post may belong, before being added to feeds to public users in block 507.

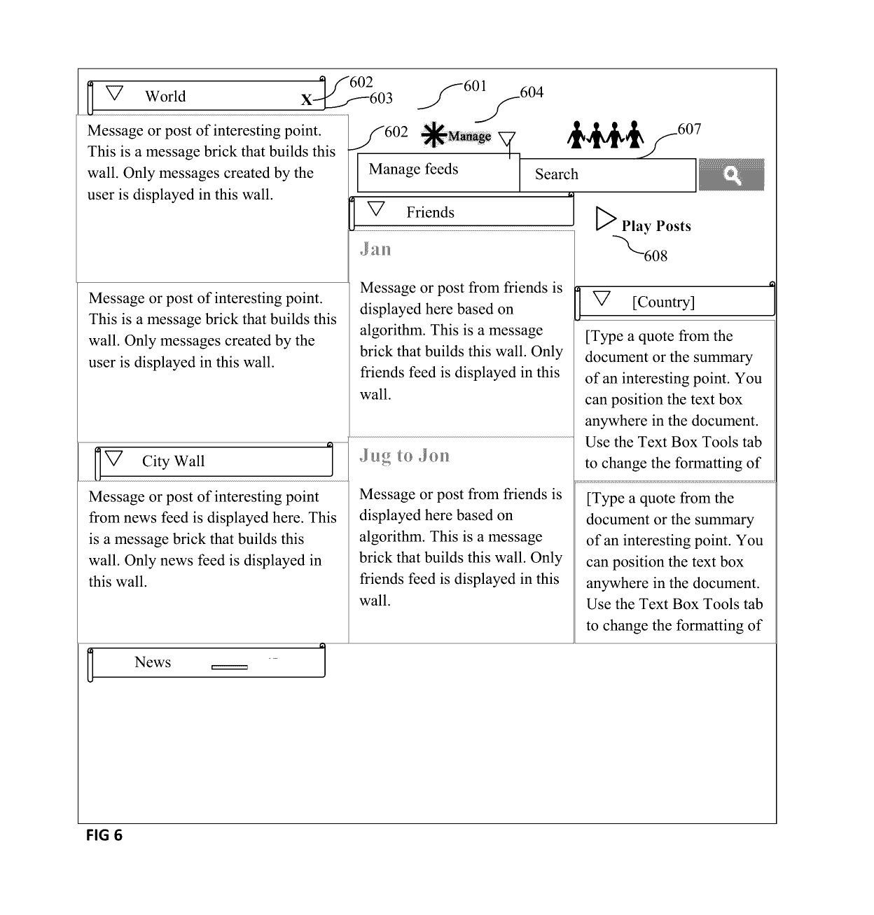

With reference to FIG. 6, a diagram of a web page that may be presented is depicted in accordance with a preferred embodiment of the present invention. Web page 601 is an example of a visually presented web page which has a layout for providing feeds from multiple categories. Each message 602 is visually presented in slices also called bricks for our purpose. Each message brick may go to a web part that has a heading segment 603 including category of the post. Clicking on ‘x’ 602 user can remove the category from user profile. Each web part also known as wall (for our purpose) may be minimized for user convenience. Manage button 604 is provided for user to manage profile including connections (contacts) and categories. With the Search feature 607 user can search posts belonging to a category. Last but not least Play posts button 608 is provided which initiates the play module that is depicted in FIG. 9.

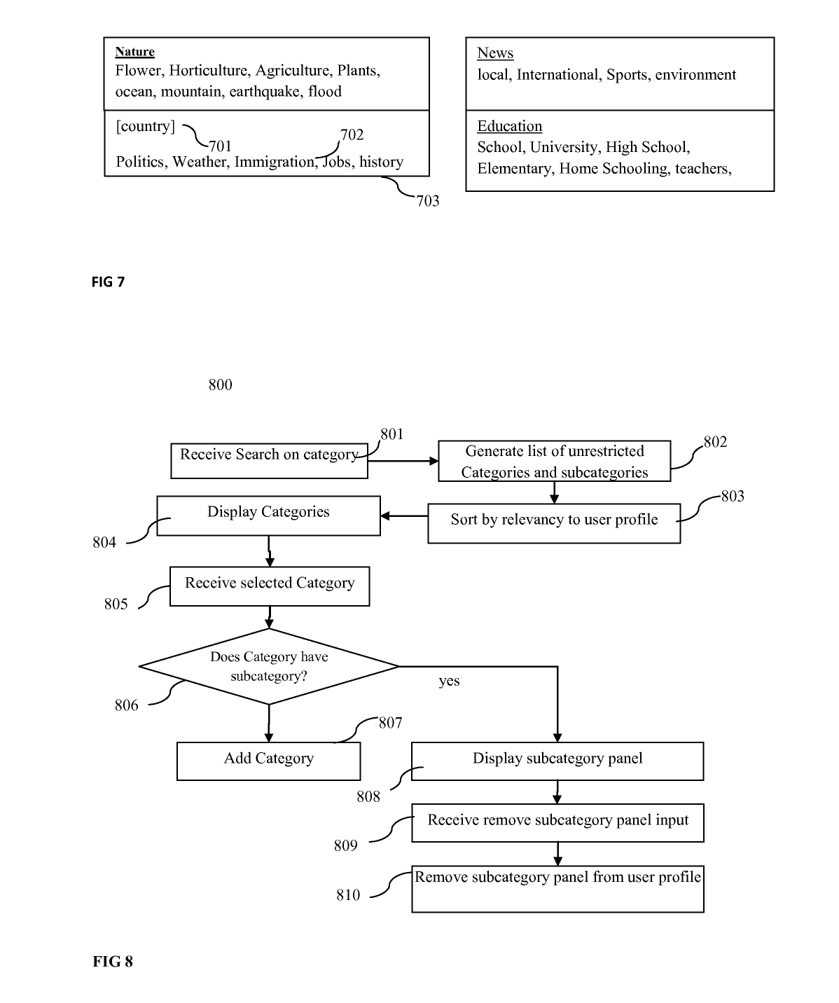

FIG. 7 illustrates exemplary grouping of subcategories into categories. This grouping is used by feed processor and post processor to direct posts to specific user walls. The block 701 shows category with block 702 showing subcategories on a panel or overlay web part at block 703

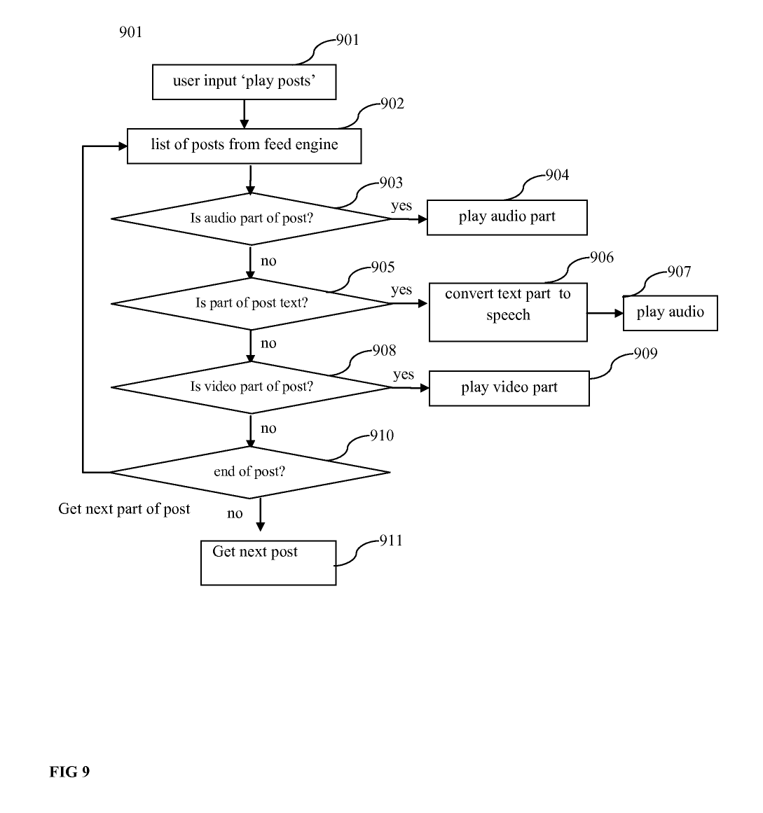

Turning next to FIG. 8 shows the process 800 of adding a category to user profile. At Block 801, the method receives category name submitted via GUI. Tags like location; originator profile are automatically attached to the post by the post processor. At block 802, method generates relevant categories. At block 803, the categories are sorted by relevancy to user profile. At block 804 categories are displayed on GUI and at block 805 methods receives selected category. Further if category has subcategory they are displayed 808 to enable user to remove 809 the subcategory panel from subscription 810. In one implementation of the system the category subscription information can be hidden.

FIG. 9 is a flow diagram of an exemplary process for presenting the content of a post in a user device. At block 901 user pushes the play button on the system. At this the system loads posts to a queue at block 902. If part of the post contains audio at block 903, then the audio part is played at block 904. If the part of the post is text then the text is converted at block 906 by text to speech mechanism and audio is played. At block 908 post part is checked for video and checked for sound. If no sound then device outputs a notice that video doesn't contain sound. A user preference may be set that don't play video without sound. Otherwise video is played.

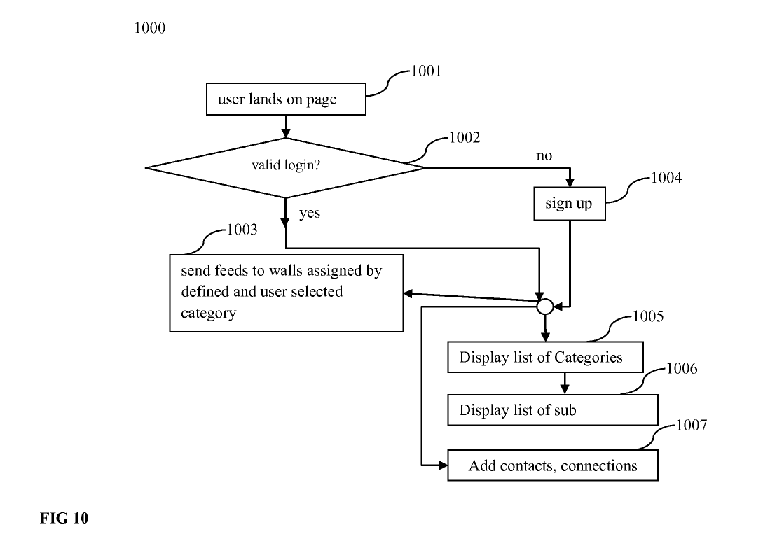

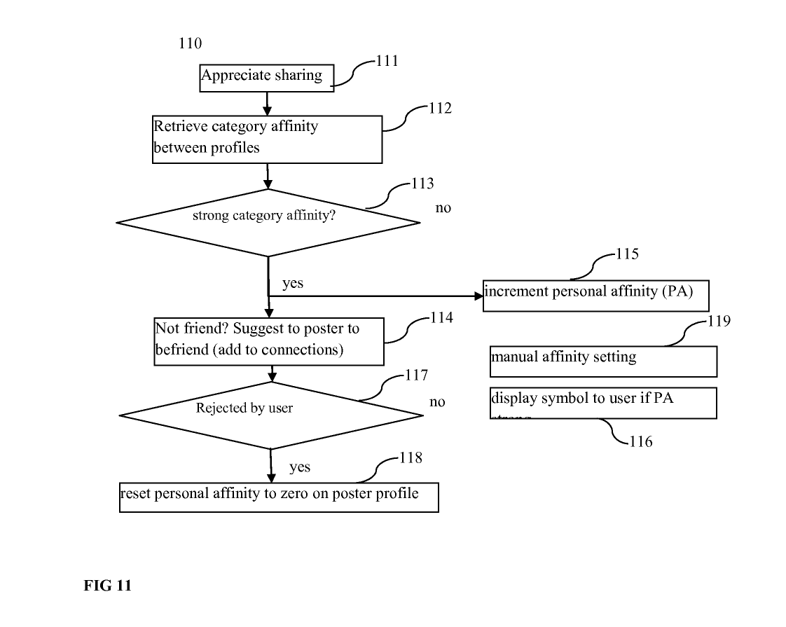

FIG. 10 is a flow diagram of an exemplary process 1000 for signup and login into the system. At block 1001 user lands on the user interface of the system. At block 1002 system checks for valid login and transmits posts to web parts which are assigned to display the posts of the category to which the post belongs at block 1003. If user selects audio play then the audio parts of the post are played and parts in other media are converted to audio and played on user device.

At block 1004 user is displayed sign up page. After signing up user is displayed initial walls and on a modal windows or overlay dialog box is asked to add contacts with whom he wishes to connect. On a model windows or overlay dialog box is displayed panels of categories and subcategories to add to the first user's profile.

FIG. 11 is a flow diagram of an exemplary process 110 for personal affinity algorithm. A viewer can have a number of affinity indicators and affinity actions available. At block 111 the method receives expressed appreciation for sharing to message poster which we will call for our purpose personal affinity. If strong category affinity match to the poster then send connect as friend request to the poster. If poster accepts the request then the first user will be added in the clique of the poster with a lower affinity score and poster will be added to first user's clique with high affinity score.

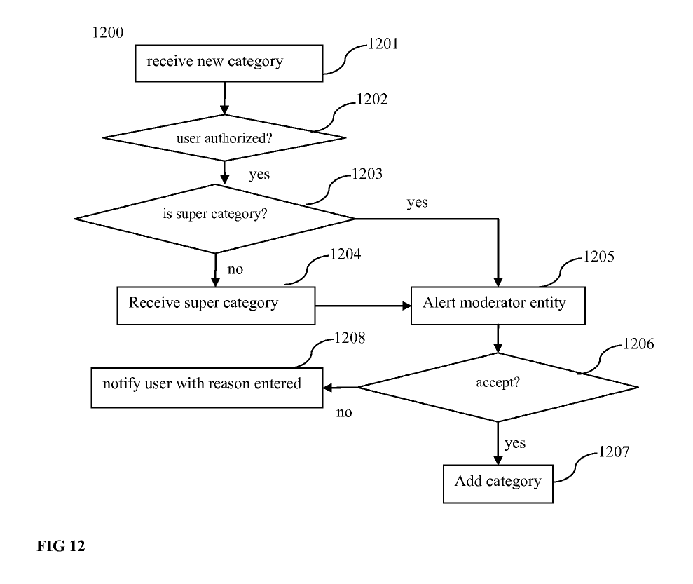

FIG. 12 is a flow diagram of an exemplary process for adding new category or subcategory to the system. When a user adds a category while submitting a new post then the process receives the request to add the category at block 1201. If the user is authorized to add category at block 1202 then at 1203 the method verifies category inside which the subcategory must reside or if category is top level category this step is skipped. System further checks if the category belongs to an existing category cloud. At block 1205, moderator entity is notified to accept the category. If accepted at block 1206 then the category is added at block 1207. The post to the new category is transmitted to users subscribed to another category in the category cloud. The category is also added automatically to poster's profile database and to all users of the system whose existing profile contains the category cloud containing the new category. At block 1205 the requester is notified that the category is not added and moderator assigns appropriate category to the post.

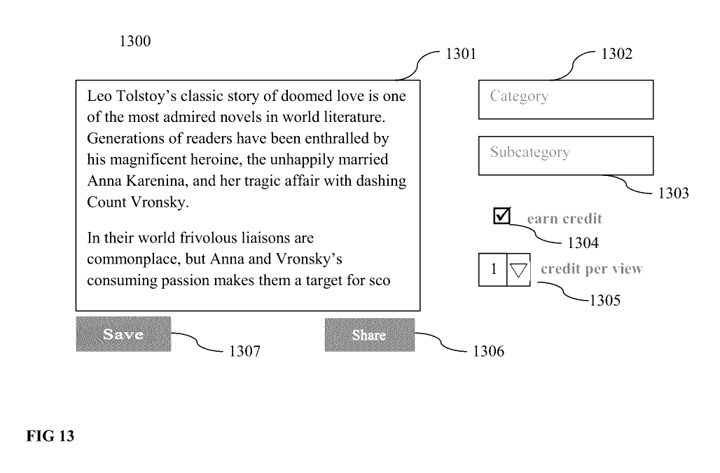

FIG. 13 shows an exemplary graphical user interface 1300 for posting a message to the system. User may add category 1302 and subcategory 1303 to the post. User may select 1304 to earn credit on views 1305. User can save 1307 the post on his own personal wall or share with users by clicking on share button 1306.

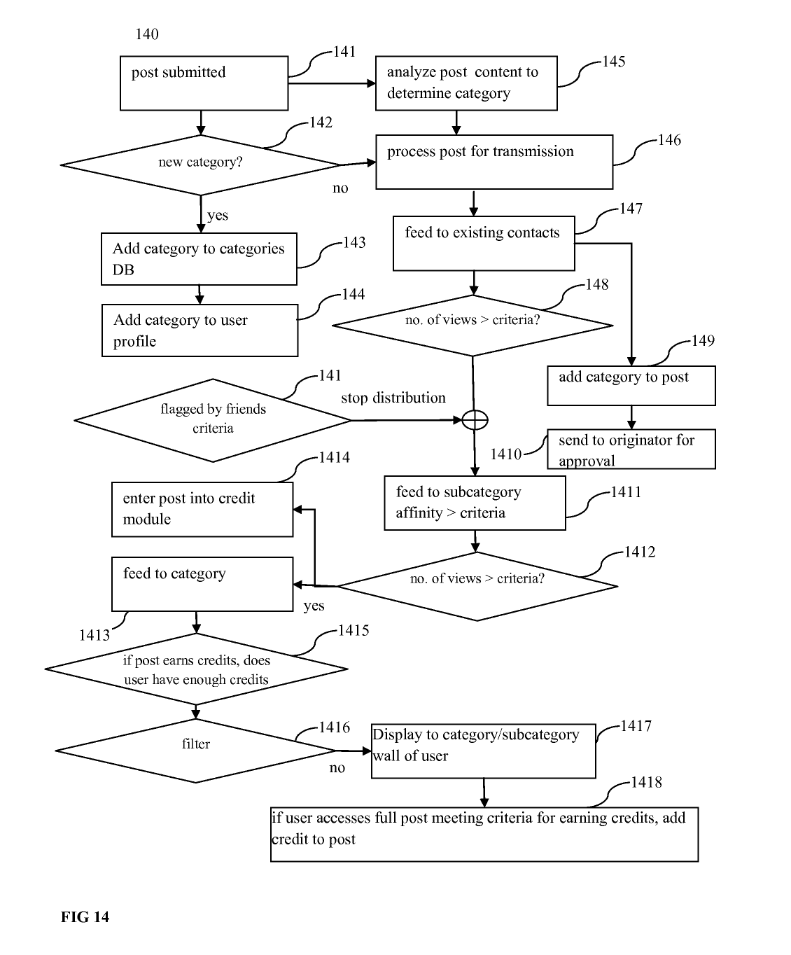

FIG. 14 is a flow diagram of an exemplary process 140 for post submission and transmission in the processor and feed generator of the system. At block 141 the originator submits post to system. If he has assigned a new category not existing in the category DB then the category is sent to assigned moderators of the system for approval. If no category is assigned then the post is only shared with friends. After approval the category is added at block 143 and at block 144 the category is added to the user profile first as restricted category. Posts to a restricted category only go to members of the category and restricted category can't be moderated by public users. Members of a restricted category may edit posts by another member of the category. Restricted category may have subcategories which inherit the restriction. Further in one embodiment the restricted category members have edit access to posts within the category if the post only has the restricted category. When approved the category is public. At block 145 the post content may be analyzed to determine category and added. After this processing, the post is transmitted to existing contacts of the poster at block 147 who are provided user interface to classify posts to a category or subcategory. The user may add a category to the post at block 149 which gets sent to originator for approval. At the same time user interface is provided to block posts that are of the selected category of the post. If the post is not flagged by poster's contacts the feed after meeting views criteria at block 148 goes to users meeting criteria with subcategory affinity at block 1411. At this point the post may start collecting credit points that can be monetized or used to gain virtual material in the system described. After checking user credits available at block 1415 the post is checked for subcategory blocking via user profile at block 1416. The filter may also provide censoring mechanism wherein the category subscription for an individual of minor age can be moderated by an adult. An individual of minor age may not have authority of changing the subscription of the category. The post is displayed on a user's wall on the web part for the category/ subcategory at block 1417. If the post originator has marked the post to earn credits then if user doesn't skip the post before a certain fixed point is reached in the post then credit is added to the post which accumulates to the originator enabling such originator to monetize posts. Credits earned can be used as virtual currency and linked to a cash value.

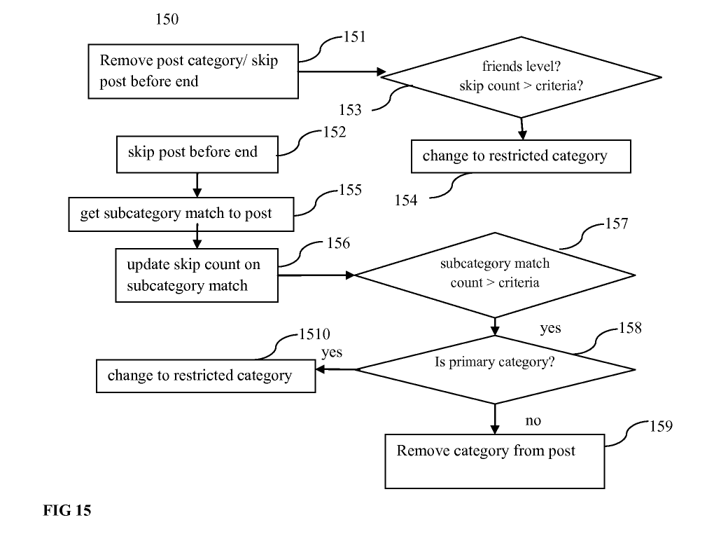

FIG. 15 is a flow diagram of an exemplary process 150 for managing a post's categories and its effects at levels of transmission. At block 151 a receiving user may manually remove a category attached to the post or skip the post before reaching towards the end. In such a case if the post is at the ‘friends’ level at block 153 then post does not flow further to subscribers of a category of the post at block 154. If post reaches the category transmission level at block 152 then at block 155 the subcategory match to post is retrieved and match count updated. At block 157 when a number of users skip the post with matching subcategory in their profile the category is removed from post if it is not a primary category at block 159. At block 158 in case of primary category the category is changed to restricted category at block 1510 where only the members explicitly added to the category have access to the post, if the post is not primary the category is remove from post at block 159.

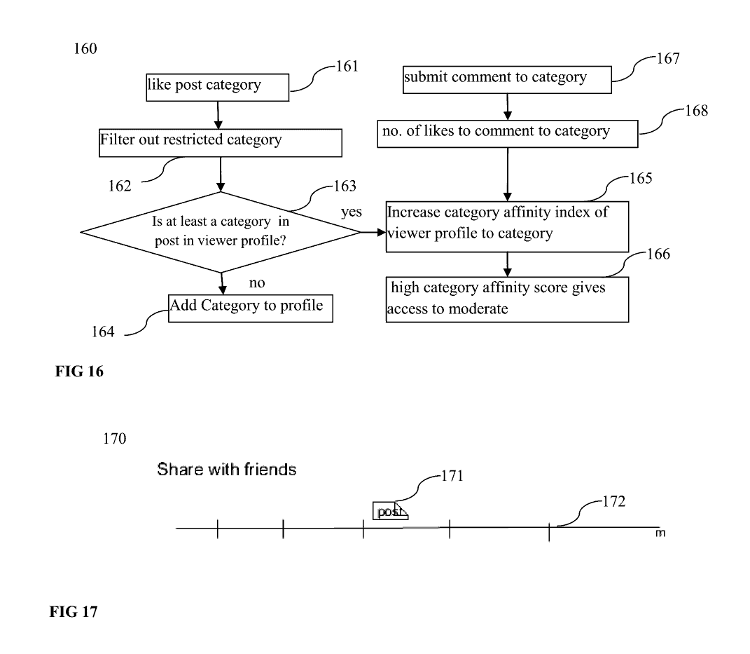

FIG. 16 is a flow diagram of an exemplary process 160 when a user likes a post at block 161. The user also has options for appreciating a post without liking the post. A post can be assigned many categories as per method. If the user likes the post category at block 161 then at block 162 the method checks if the category is not restricted. If not restricted the post category is added to user profile after checking for—if not exists at block 163, at block 164. Else category affinity index for the profile category is incremented at block 165. The process flow also arrives at block 165 when user submits comment to a post of a category at block 167. At block 168 a user may need to accumulate certain number of likes to the category postings to be able to post comment. At block 166, high category affinity score gives a user access to moderate category and posts in the category such as removing a category from a post.

FIG. 17 shows an exemplary graphical user interface 170 for posting to friends with affinity index selected on a scale measuring system 172 by moving an icon 171 by a pointer device.

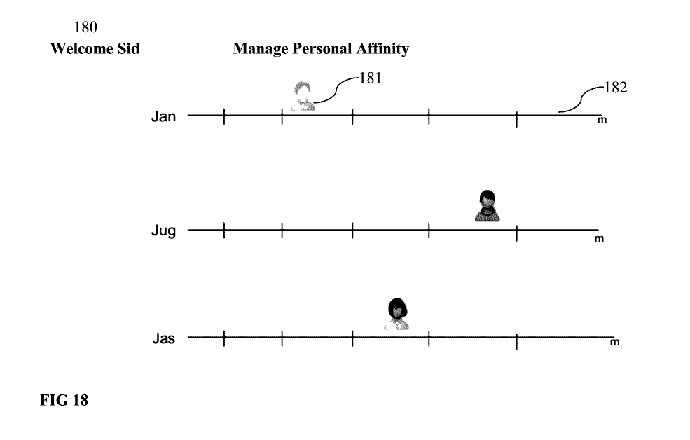

FIG. 18 shows an exemplary graphical user interface 180 for managing personal affinity to contacts. The contact 181 can be moved by a computer mouse or user device pointer on a visual scale 182.

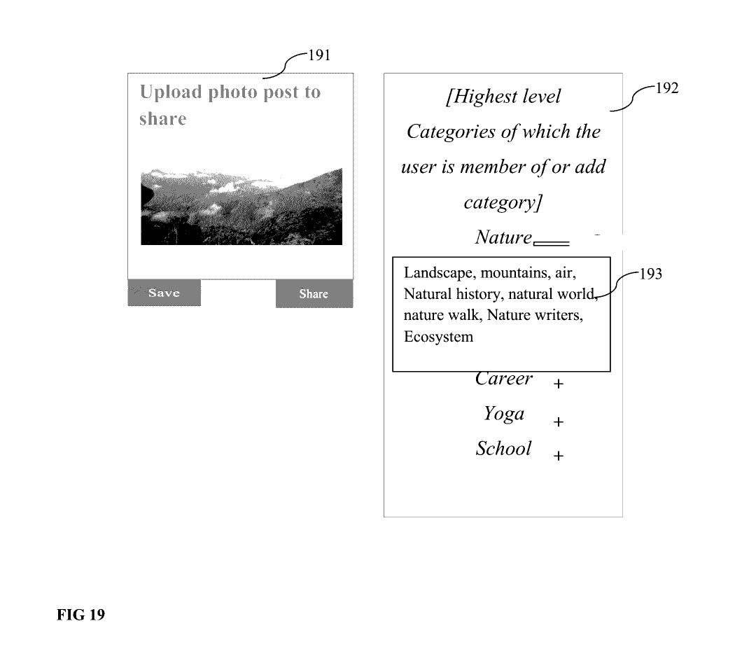

FIG. 19 shows an exemplary graphical user interface for posting to the system similar to the FIG. 13. User interface consists of a uploading mechanism block 191 and user can select the category 192 and subcategories within it 193 for the post. User can then save for his own record or share with others via user elements provided. The various operations, processes, and methods of the described system may be embodied in a non-transitory computer-readable medium having computer-executable instructions for causing a server comprising processor(s) and associated memory to manage electronic communications within a social group of a social network, and can be performed in any order (e.g., including using means for achieving the various operations).

Embodiments of the invention provide a system, method and computer program product for providing means of categorizing posts to creator and transmitting those posts to users subscribed to the topics and categories of which the post is indexed. The classification result can then be used to determine what type of other content to associate with the classified content.

The presentation layer may make the information from the feeds engine available via the audio interface in the mobile device and personal computer or table computer. Further the presentation layer of the system can convert text to audio, audio format extraction from video and audio recorded by the creator of the post.

If new category tag is added and attached to a post the category tag will be submitted to the category database which needs approval by users with moderator profile to add the category or subcategory to category cloud except if indexed as group. If indexed as a ‘group’ category the members are invite only by the moderator of the category. All posts in that category are viewable by only the members of the group.

Posts generated by the feed processor are fed to user GUI. As the users submit new posts and shares articles the friends in his circle come nearer or move further away in the affinity measurement algorithm depending on the category affinity score.

The method includes automatically generating a multiplicity of feed that contains information relevant to a user which in one embodiment may be organized by category and topics set by the user, wherein the organization may be defined by a user selection from provided options. Within each area, the content may be presented as per user setting.

To further discover content, users may perform searches, possibly within a category or subcategory area. Users may also be allowed to filter by date, events, and/or affinity. If an exact match does not exist for a search query, the next best results may be determined with the context of the original search. This allows users to locate key content more accurately and return search results with possibly more intuitive connections.

The method may further appeal to users by making advertisement more relevant and effective for any platform with user profile data and content. Advertisement may be displayed based on relevancy to currently viewed content and basic profile information, including location, gender, age, etc.

Patent Citations

| | | Publication | | |
|---|---|---|---|---|
| Cited Patent | Filing date | date | Applicant | Title |
| U.S. Pat. No. | 16 Jun. 2003 | 27 Jun. 2006 | Friendster, Inc. | System, method and apparatus for |
| 7,069,308 | | | | connecting users in an online |
| | | | | computer system based on their |
| | | | | relationships within social networks |
| WO2012170018 | 8 Jun. 2011 | 13 Dec. 2012 | Hewlett-Packard | Determining and visualizing social |
| A1 | | | Development | media expressed sentiment |
| | | | Company, L.P. | |
| US20100119053 | 13 Jan. 2009 | 13 May 2010 | Buzzient, Inc. | Analytic measurement of online |
| | | | | social media content |
| US20060123053 | 1 Dec. 2005 | 8 Jun. 2006 | Insignio | Personalized content processing |
| | | | Technologies, Inc. | and delivery system and media |
| US20050266829 | 16 Apr. 2004 | 1 Dec. 2005 | Lg Elcectronics, Inc. | Speech-to-text messaging system |
| | | | | and method |
| U.S. Pat. No. | 26 Apr. 2004 | 11 Sep. 2007 | Yahoo! Inc. | Method and system for |
| 7,269,590 | | | | customizing views of information |
| | | | | associated with a social network |
| | | | | user |
| U.S. Pat. No. | 11 Aug. 2006 | 19 Mar. 2013 | Facebook, Inc. | Providing a newsfeed based on |
| 8,402,094 | | | | user affinity for entities and |
| | | | | monitored actions in a social |
| | | | | network environment |

1. A system and method of social media for dynamically presenting and organizing posts by moderated clouds of category and subcategory comprising:
a posts database including a plurality of posts, wherein each post includes content and metadata such as subject, category, creator, audience level; user comments, link to original article url (if clipped);
determine by a process running on the server of a social networking system, posts that are within the user's sphere of interest as determined by the post's category and subcategory that match category data from user's profile and personal affinity to the second user that is viewable on a measurement system;
a profile database including user, location, privacy preference, category subcategory preference, credit balance, badge;
post tag includes user data from user profile database, further wherein the user data associated with each post includes a grant to access the post for editing or adding category tag by users with strong affinity to the creator of the post;
Category cloud that can be attached to user profile data and to a post;
Server module with indexing component for indexing the posts based on category and subcategory;
a feed generator engine which assembles posts from a posts database wherein each post may include multiple formats of content and one or more tags including category

2. a system and method of claim 1, further comprising a feed engine transmitting the plurality of posts to a client machine, wherein the plurality of posts are transmitted according to the matching of posts categories and topics to profile preference setting.

3. a system and method of claim 1 wherein a process determines a relevance index to user for each of a plurality of a post's category, subcategory combination measured by the category affinity module;

4. in one embodiment a user interface component comprising a panel allows the user to change connection strength score on personal affinity to a contact and post category affinity, when a Appreciation indicator is received the affinity algorithm computes connection strength score;

5. A system and method of claim 1, further comprising:
Selectively alerting a moderator entity of a new category added by an originator of a post;
the moderator entity accepts and/or adds category to relevant category cloud;

6. A system and method of claim 1 wherein the presentation displays multiple feeds generated by feed generator based on user profile and post settings such as affinity index to poster,
a. the presentation can be visual
b. browser plug-in or web module which converts the written words into audio
c. recorded audio content
d. video format converted into audio format by extracting audio

7. A system and method of claim 1 where in one embodiment the presentation plays audio of each post parts for each post in sequence going from category to category according to preferences set by the user;
the presentation module determines how a post or part of the post is presented to user and presents the post by
a. playing audio part of post
b. detecting video sound, if no sound inform to user otherwise play video with audio
c. converting text to speech and playing speech

8. A system and method of claim 1 wherein the server is notified when a part of a multi part post of at least a certain duration is presented to the end user comprising:
method which deducts credits from the viewer and adds credit points to the original poster;
method which adds category affinity points and personal affinity points to the user profile;

9. A system and method of claim 1 wherein the server is notified when a end user skips a post notifying a method which may reduce category affinity

10. A system and method of claim 1 wherein the feed generator assembles list of one or more posts in prioritized order based on relevancy to data associated with a receiving user in the profile database and to the post category in the category cloud.

11. A system and method of claim 1, comprising:
presenting with the post user interface elements providing a first user with option to like post and appreciate posting;
receiving the like post adds category affinity index and if already connected to poster adds personal affinity) measure of connection strength);

12. A system and method of claim 1 with module for conducting search in the databases within the system such as the posts repository, category repository etc. where a) there is one or more search input;
b) in one embodiment one of the search input may be prefilled with part of the data from said repositories;
c) method detects the language of the search input;
e) categorizing the search by extracting the categories from the posts and categories repository.
g) executing the search by presenting the results to the interface.

13. in one embodiment of a system and method of claim 1 comprising:
play module configured to retrieve post from feed engine;
extract index of each part of a multipart post;
play each part according to preconfigured action;

14. A system and method of claim 1, wherein if user action meets criteria then credit is added to post or an entity;
action comprising of
a post is scrolled till end of the post
if post is not skipped before end of a part of a multi-part post which may comprise of number of format parts such as audio, video, text;

15. A system and method of claim 1, wherein a post will be reviewed by user who has earned reviewer status by accumulating points for actions performed on the described system;

16. A system and method of claim 1, wherein poster wrongly categorizing a posted message will be penalized by processes within the system;

17. A system and method of claim 1, wherein a reviewer may earn credit points for posting review accepted by original poster;

18. A system and method of claim 1, wherein connection request message may be generated after evaluating first user's category affinity match to the second user;

19. A system and method of claim 1, wherein category affinity and personal affinity are displayed on a scale such that first user can gauge the affinities on a measurement system;
